(19) United States
(12) Patent Application Publication
(10) Pub. No.: US 2022/0094527 A1
(43) Pub. Date: Mar. 24, 2022

(54) SERVICE PROVISION SYSTEM AND SERVICE PROVISION METHOD

(71) Applicant: KABUSHIKI KAISHA TOKAI RIKA DENKI SEISAKUSHO, Aichi (JP)

(72) Inventors: Kenji NARUMI, Aichi (JP); Satoshi ARIKURA, Aichi (JP); Yuki MORI, Aichi (JP); Masahiko OYA, Aichi (JP); Masahiro ARAKAWA, Aichi (JP)

(73) Assignee: KABUSHIKI KAISHA TOKAI RIKA DENKI SEISAKUSHO, Aichi (JP)

(21) Appl. No.: 17/418,460

(22) PCT Filed: Dec. 20, 2019
(86) PCT No.: PCT/JP2019/050127

§ 371 Date: Jun. 25, 2021

(30) Foreign Application Priority Data
Dec. 27, 2018 (JP) 2018-245260

(51) Int. Cl. H04L 9/08; H04W 12/04; H04W 4/80

(52) U.S. Cl. CPC H04L 9/088; H04W 4/80; H04W 12/04

(57) ABSTRACT

A service provision system carries out a service in which, when a vehicle is lent to another user, key information separate from that delivered to a user terminal is delivered to the other user's terminal, whereby even the other user is allowed to drive the vehicle. A notification unit issues notification of a commodity or a service pertaining to the use of the vehicle when the key information is delivered to the other user's terminal.

### TECHNICAL FIELD

The present disclosure relates to a service provision system and a service provision method for providing a service related to an operation target for a user.

### BACKGROUND ART

JP-A-2015-154283 discloses a technique in which authentication information (for example, a key ID or the like) corresponding to a key is registered in another mobile terminal different from a mobile terminal used as a vehicle key by a user, so that the vehicle can be operated by the other mobile terminal. Examples of the mobile terminal include a high-performance mobile phone. In this way, when the high-performance mobile phone can be used as a vehicle key, it is not necessary to carry a dedicated electronic key when using the vehicle and convenience is improved.

### SUMMARY OF INVENTION

Here, for example, it is assumed that a mobile terminal carried by another user is given authentication information equivalent to a key and the vehicle is rented to the other user. However, in a case where the other user who temporarily rents the vehicle does not have vehicle insurance, an undesirable usage situation of an operation target may occur.

Therefore, in a case where the operation target is rented to the other user, it is required to prevent the occurrence of an undesirable use situation for the operation target.

One aspect for responding to the above request is a service provision system in which an operation of an operation target is allowed when authentication is established via short-range wireless communication between an authentication device connected to the operation target and a mobile terminal having acquired key information required for the authentication, the service provision system including:

a first delivery unit configured to deliver first key information as the key information to a mobile terminal carried by a user of the operation target;

a second delivery unit configured to deliver second key information including information different from the first key information as the key information to a mobile terminal carried by another user different from the user; and

a notification unit configured to notify a mobile terminal carried by the other user of a commodity or a service suitable for use of the operation target through network communication.

One aspect for responding to the above request is a service provision method in which an operation of an operation target is allowed when authentication is established via short-range wireless communication between an authentication device connected to the operation target and a mobile terminal having acquired key information required for the authentication, the service provision method including:

a step of delivering first key information as the key information to a mobile terminal carried by a user of the operation target;

a step of delivering second key information including information different from the first key information as the key information to a mobile terminal carried by another user different from the user; and

a step of notifying a mobile terminal carried by the other user of a commodity or a service suitable for use of the operation target through network communication.

According to the configuration of each aspect described above, in a case where the operation target is rented to the other user who carries the mobile terminal to which the second key information, which is different from the first key information delivered to the mobile terminal carried by the user, is delivered, the commodity or the service suitable for use of the operation target is notified to the mobile terminal carried by the other user. Therefore, in a case where the operation target is rented to the other user, it is possible to prevent the occurrence of an undesirable use situation for the operation target.

### BRIEF DESCRIPTION OF DRAWINGS

FIG. 1 illustrates a configuration of an electronic key system and an authentication system according to an embodiment.

FIG. 2 illustrates a flow for authentication of key information registered in a mobile terminal.

FIG. 3 illustrates a flow when operating a vehicle with the mobile terminal.

FIG. 4 illustrates a configuration of a service provision system.

FIG. 5 illustrates a flow of commodity provision (at a time of purchasing a commodity).

FIG. 6 illustrates a flow of commodity provision (at a time of not purchasing a commodity).

### DESCRIPTION OF EMBODIMENTS

A service provision system and a service provision method according to an embodiment will be described in detail below with reference to the accompanying drawings.

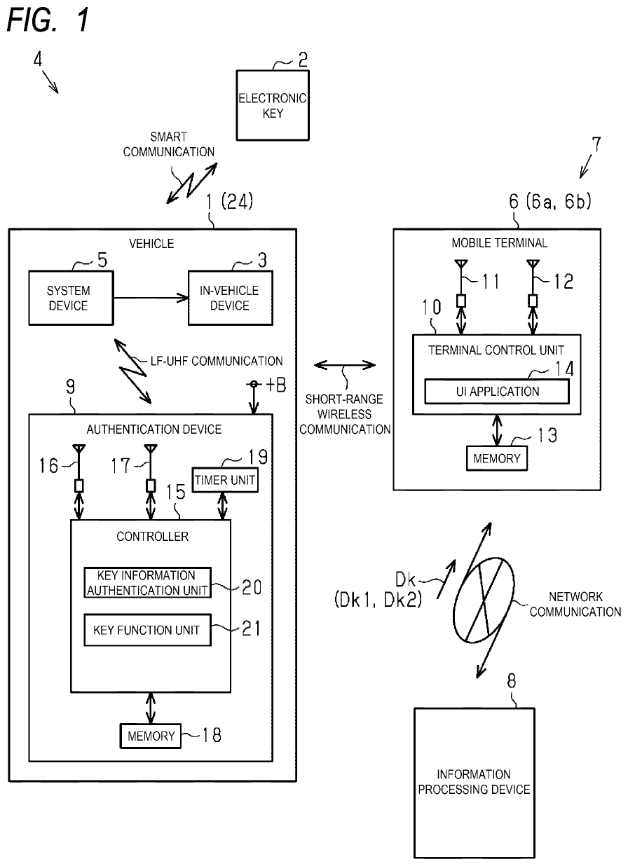

As illustrated in FIG. 1, a vehicle 1 includes an electronic key system 4 that permits or executes an operation of an in-vehicle device 3 through wireless ID collation with an electronic key 2. It is preferable that the electronic key system 4 is a smart collation system that performs ID collation (smart collation) by narrow-band radio in the wake of communication from the vehicle 1. The in-vehicle device 3 includes, for example, a door lock device that opens and closes a vehicle door, an engine of the vehicle 1, and the like.

The electronic key system 4 includes a system device 5 that operates the electronic key system 4 in the vehicle 1. An electronic key ID and a key unique key to be used in the smart collation are registered in the electronic key 2 and the system device 5. The electronic key 2 and the system device 5 perform smart collation through bidirectional communication in which communication is executed by transmitting and receiving radio waves to and from each other. The smart collation executes, for example, electronic key ID collation for confirming whether or not an electronic key ID is correct, challenge response authentication using a key unique key, or the like. Radio waves in the low frequency (LF) band are used for radio wave transmission from the system device 5 to the electronic key 2, and radio waves in the ultra high frequency (UHF) band are used for radio wave transmission from the electronic key 2 to the system device 5.

When smart communication (outdoor smart communication) is executed with the electronic key 2 located outdoors, the system device 5 permits or executes locking and unlocking of a vehicle door if smart collation (outdoor smart collation) is established. As a result, the vehicle door is unlocked when a vehicle outside door handle is touch-operated, and the vehicle door is locked when a lock button on vehicle outside door handle is operated. When smart communication (indoor smart communication) is executed with the electronic key 2 located indoors, the system device 5 permits a transition operation of a vehicle power supply if smart collation (indoor smart collation) is established. As a result, when an engine switch in a driver seat is pressed while depressing a brake pedal, the engine starts.

The vehicle 1 includes a wireless authentication function (authentication system 7) that permits or executes an operation of the in-vehicle device 3 via the authentication through the short-range wireless communication with the mobile terminal 6 in which key information Dk is registered via the network communication. The authentication system 7 registers, for example, encrypted key information Dk from the outside (information processing device 8 in the present embodiment) to the mobile terminal 6. The authentication system 7 authenticates the key information Dk through short-range wireless communication with an authentication device 9 mounted on the vehicle 1, and sets the authentication result as one condition of the operability of the vehicle 1. The mobile terminal 6 is preferably, for example, a high-performance mobile phone.

The information processing device 8 includes a first delivery unit 22 that delivers first key information (hereinafter, referred to as first key information Dk1), which is one of the key information Dk, to the mobile terminal 6 (hereinafter, referred to as a user terminal 6a) carried by a user of the vehicle 1. When the first delivery unit 22 receives a request for delivery of the first key information Dk1 from the user terminal 6a, the first delivery unit 22 delivers the first key information Dk1 to the user terminal 6a via the network communication.

When the key information Dk is given to the user terminal 6a used by an owner of the vehicle 1, it is preferable that the key information Dk is the first key information Dk1 positioned as an owner key that does not include restrictions on the operation of the vehicle 1. When the key information Dk is given to a mobile terminal 6 (hereinafter, referred to as another user terminal 6b) used by another person who is not the owner of the vehicle 1 (a family member, a friend or the like), it is preferable that the key information Dk is key information positioned as a one-time key (one-time password) that includes restrictions on the operation of the vehicle 1 as different information (hereinafter, referred to as second key information Dk2). In the present embodiment, the different information is information that is permitted to be used only once, and includes an element of usage time restriction.

The mobile terminal 6 includes a terminal control unit 10 that controls the operation of the mobile terminal 6, a network communication module 11 that performs network communication in the mobile terminal 6, a short-range wireless module 12 that performs the short-range wireless communication in the mobile terminal 6, and a memory 13 in which data can be written and rewritten. When the key information Dk is acquired from the information processing device 8 through the network communication, the mobile terminal 6 writes and stores the key information Dk in the memory 13. The short-range wireless communication is preferably, for example, Bluetooth (registered trademark).

The mobile terminal 6 includes a user interface application 14 that manages the operation of the authentication system 7 in the mobile terminal 6. The user interface application 14 is, for example, downloaded from the information processing device 8 and registered in the terminal control unit 10. The user interface application 14 executes various processes such as a procedure of using the vehicle by the mobile terminal 6 (a setting procedure for allowing the mobile terminal 6 to operate the vehicle), an operation of locking and unlocking the vehicle door, an operation of starting the engine of the vehicle 1, and the like.

The authentication device 9 includes a controller 15 that controls the operation of the authentication device 9, a smart communication block 16 that performs smart communication in the authentication device 9, a short-range wireless module 17 that performs short-range wireless communication in the authentication device 9, a memory 18 in which data can be written and rewritten, and a timer unit 19 that manages date and time in the authentication device 9. The authentication device 9 has a one-to-one relationship with the vehicle 1 by associating an authentication device ID registered therein with, for example, a vehicle body ID (vehicle body number) of the vehicle 1. The timer unit 19 includes, for example, a software timer.

The authentication device 9 includes a key information authentication unit 20 that authenticates whether or not the key information Dk registered in the mobile terminal 6 is correct, and a key function unit 21 that operates the authentication device 9 like the electronic key 2. The key information authentication unit 20 and the key function unit 21 are provided in the controller 15. The key information authentication unit 20 acquires the key information Dk from the mobile terminal 6 through short-range wireless communication, and authenticates the key information Dk. When the authentication of the key information Dk is established, the key information authentication unit 20 switches the key function unit 21 to an ON state (enabled). When the key function unit 21 is switched to the ON state, it becomes possible to execute communication (wireless communication or smart communication) with the system device 5 through the electronic key system 4.

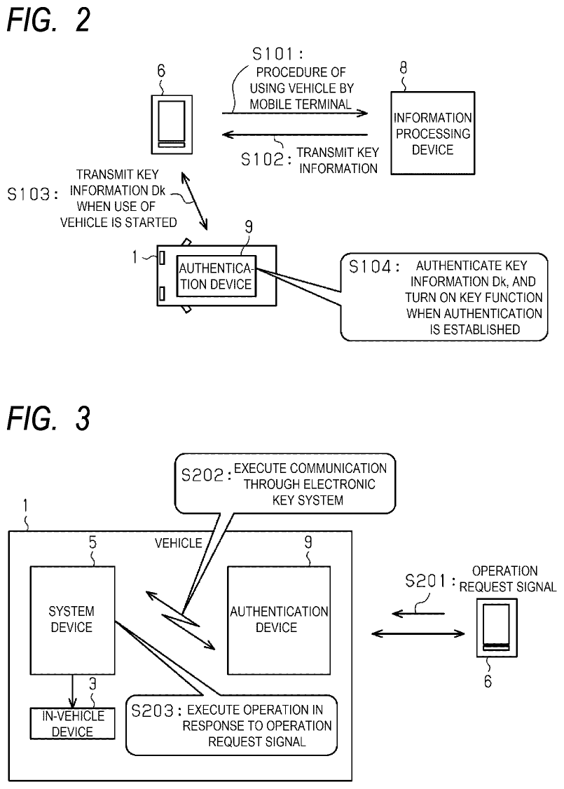

As illustrated in FIG. 2, when the vehicle 1 is operated by the mobile terminal 6, the key information Dk is registered in the mobile terminal 6, and the key information Dk is authenticated between the vehicle 1 and the mobile terminal 6. In this case, first, in step S101, the mobile terminal 6 executes the procedure of using the vehicle by the mobile terminal 6 with the information processing device 8 through network communication. This procedure is, for example, authentication for confirming a user ID and a password given at the time of use registration of the authentication system 7.

In step S102, when the procedure of using the vehicle by the mobile terminal 6 is completed, the first delivery unit 22 of the information processing device 8 generates the key information Dk (here, the first key information Dk1), and transmits the generated key information Dk to the mobile terminal 6 through the network communication. At this time, the first delivery unit 22 generates the first key information Dk1 using the information acquired during the procedure of using the vehicle by the mobile terminal 6. When the first key information Dk1 is delivered to the user terminal 6a, the first key information Dk1 includes encryption information generated by using, for example, “permanent usage notification”, “terminal ID (ID of the user terminal 6a)”, “user authentication key” and the like as the original information and a cryptographic key of the authentication device 9 (for example, the unique key of the authentication device) provided on the vehicle 1 as an encryption key, and substituting these into an encryption expression (encryption algorithm). The permanent usage notification is a notification indicating that the key information Dk can be used without any time or period limitation. The user authentication key is, for example, a key used in cryptographic communication between the mobile terminal 6 and the authentication device 9 when an operation is performed on the vehicle by the mobile terminal 6. When receiving the key information Dk from the information processing device 8, the mobile terminal 6 writes and stores the key information Dk in the memory 13.

In step S103, when the short-range wireless communication with the vehicle 1 is established, the mobile terminal 6 transmits the key information Dk registered in the mobile terminal 6 itself through the short-range wireless communication. The key information Dk is transmitted to the authentication device 9 through, for example, Bluetooth Low Energy (BLE).

In step S104, when the authentication device 9 receives the key information Dk from the mobile terminal 6, the authentication device 9 authenticates the key information Dk.

In the present embodiment, the key information authentication unit 20 decrypts the key information Dk using the cryptographic key (for example, the unique key of the authentication device), and confirms whether or not the decryption is successful. In a case of the first key information Dk1, when the decryption of the first key information Dk1 is successful, it is possible to acquire the original information such as the “permanent usage notification”, the “terminal ID”, and the “user authentication key” included in the first key information Dk1. As a result, the owner of the vehicle 1 can operate the vehicle 1 with the mobile terminal 6 thereof.

When the authentication of the key information Dk is successful, the authentication device 9 shifts to an “authentication completed state” of the key information Dk, and the key function unit 21 is turned on (the smart function is enabled). Therefore, the key function unit 21 can perform various types of communication (wireless communication or smart communication) through the electronic key system 4. When the authentication of the key information Dk is successful, the authentication device 9 writes and stores the key information Dk and the user authentication key in the memory 18. In wireless communication or smart communication, collation of the authentication device ID is executed.

When the authentication of the key information Dk is successful, the authentication device 9 notifies the mobile terminal 6 of the user authentication key acquired in the authentication through the short-range wireless communication. When receiving the user authentication key from the authentication device 9, the mobile terminal 6 registers the user authentication key in the memory 13. As described above, the user authentication key is registered in both the mobile terminal 6 and the authentication device 9. Therefore, when the vehicle 1 is operated by the mobile terminal 6 through the authentication device 9, the user authentication key is used for the cryptographic communication between the mobile terminal 6 and the authentication device 9. The user authentication key is preferably updated to a new key each time short-range wireless communication between the mobile terminal 6 and the authentication device 9 is established.

As illustrated in FIG. 3, in a case where the vehicle 1 is operated by the mobile terminal 6 in which the key information Dk is registered, in Step S201, when an operation request button (a display button on the screen) of the mobile terminal 6 is operated in the authentication completed state, the mobile terminal 6 transmits an operation request signal corresponding to the button to the authentication device 9 via short-range wireless communication. The operation request button includes, for example, an unlocking request button operated when the vehicle door is to be unlocked, a locking request button operated when the vehicle door is to be locked, an engine start request button operated when the vehicle 1 is allowed to start the engine, and the like. The operation request signal is a signal including a command corresponding to the operated operation request button. The operation request signal is encrypted and transmitted by, for example, a user authentication key.

In step S202, when the key function unit 21 receives the operation request signal from the mobile terminal 6 in the ON state, the key function unit 21 executes communication (wireless communication or smart communication) through the electronic key system 4, and notifies the system device 5 of the operation request signal in the process of the communication. In the present embodiment, for example, in the case of the operation of locking and unlocking the vehicle door, a door locking signal or a door unlocking signal is wirelessly transmitted from the key function unit 21. In addition, in the case of an engine start operation, smart collation is executed between the system device 5 and the key function unit 21, and it is confirmed whether or not smart collation is established.

In step S203, the system device 5 executes an operation in response to the operation request signal notified from the authentication device 9 through communication (wireless communication or smart communication) with the authentication device 9 (the key function unit 21). As a result, locking and unlocking of the vehicle door, permission of the engine start operation, and the like are executed.

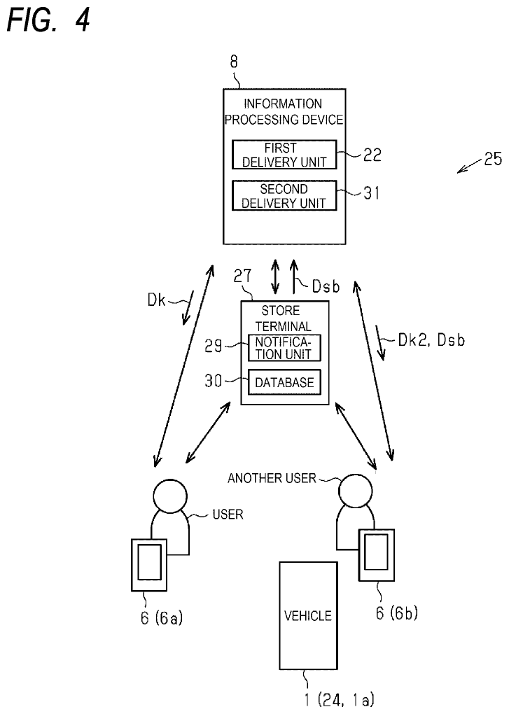

As illustrated in FIG. 4, a service provided by the service provision system 25 using the delivery of the key information Dk is provided to the vehicle 1, which is an example of an operation target 24 of the mobile terminal 6. The service provision system 25 according to the present embodiment notifies another mobile terminal 6 (the other user terminal 6b), to which the key information Dk is delivered, of a commodity or a service related to the operation target 24 through the network communication. In the present embodiment, the service provision system 25 provides a commodity or a service related to the use of the vehicle when the key information Dk (the second key information Dk2) different from that given to the mobile terminal 6 (user terminal 6a) of the user of the vehicle 1 is delivered to the other mobile terminal 6 (the other user terminal 6b) and the vehicle 1 is lent. In the present embodiment, the commodity or the service is preferably, for example, vehicle insurance that guarantees payment of the costs when a trouble occurs in the vehicle 1.

The service provision system 25 includes a store terminal 27 that manages a service for commodity provision. In the present embodiment, the store terminal 27 is, for example, a terminal of an insurance commodity sales company. The store terminal 27 can perform network communication with the user terminal 6a, the other user terminal 6b, the information processing device 8, and the like. The store terminal 27 is installed in, for example, a store or the like operated by an insurance company. The store terminal 27 may be either a desktop type or a mobile type.

The service provision system 25 includes a notification unit 29 that notifies the mobile terminal 6 (the other user terminal 6b in the present embodiment) to which the second key information Dk2 is delivered of a commodity or a service related to the operation target 24. The notification unit 29 is provided in the store terminal 27. When the vehicle 1, which is the operation target 24, is rented to another user, the notification unit 29 notifies a commodity or a service related to the vehicle 1 through the network communication. In the present embodiment, the commodity or the service is an insurance commodity of the vehicle 1. When the vehicle 1 is rented to the other user, the notification unit 29 provides an insurance commodity to the other user terminal 6b. In the present embodiment, the notification unit 29 transmits commodity service information Dsb as the insurance commodity to the other user terminal 6b via the information processing device 8.

The store terminal 27 is provided with a database 30 in which insurance to which each user subscribes is managed. The database 30 collectively manages what kind of insurance each user who has registered the key information Dk in the mobile terminal 6 has subscribed to, for example. The notification unit 29 receives the contact of the rental of the vehicle 1 from the user terminal 6a, and confirms whether or not the other user who is a rental partner has insurance by referring to the database 30. In addition, the notification unit 29 extracts an optimal commodity (insurance) for the other user who rents the vehicle 1, and provides the commodity to the other user so as to recommend the purchase of the commodity.

The service provision system 25 includes a second delivery unit 31 that delivers the key information Dk (in the present embodiment, the second key information Dk2) capable of operating the vehicle 1 to the mobile terminal 6 of the other user (the other user terminal 6b). The second delivery unit 31 is provided in the information processing device 8. In the present embodiment, when the user rents the vehicle 1 to the other user, the second delivery unit 31 delivers the second key information Dk2 to the other user terminal 6b when the other user purchases the commodity notified by the notification unit 29. The second key information Dk2 is different from the first key information Dk1 delivered to the user terminal 6a. The second key information Dk2 is preferably a one-time key (one-time password) in which use of the vehicle 1 is restricted.

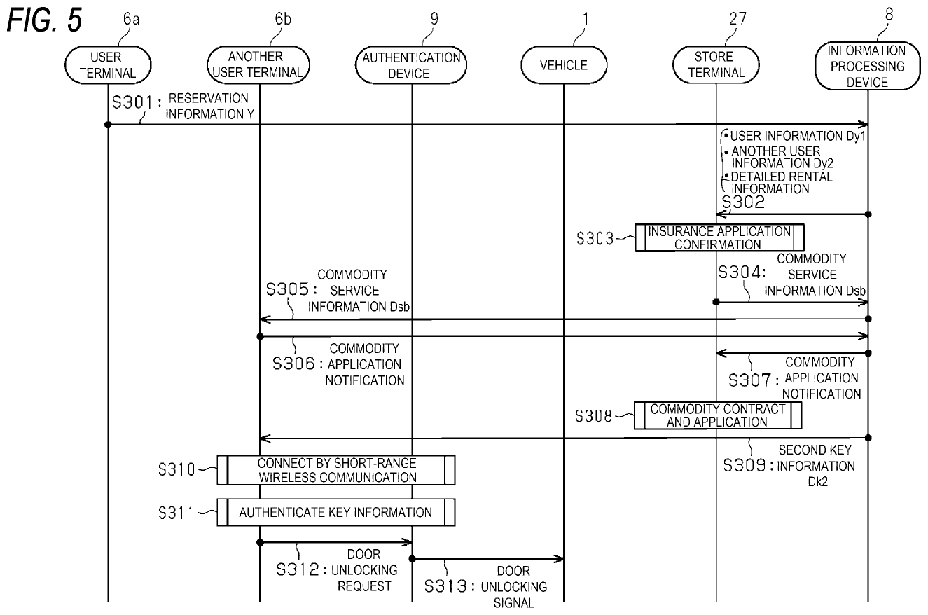

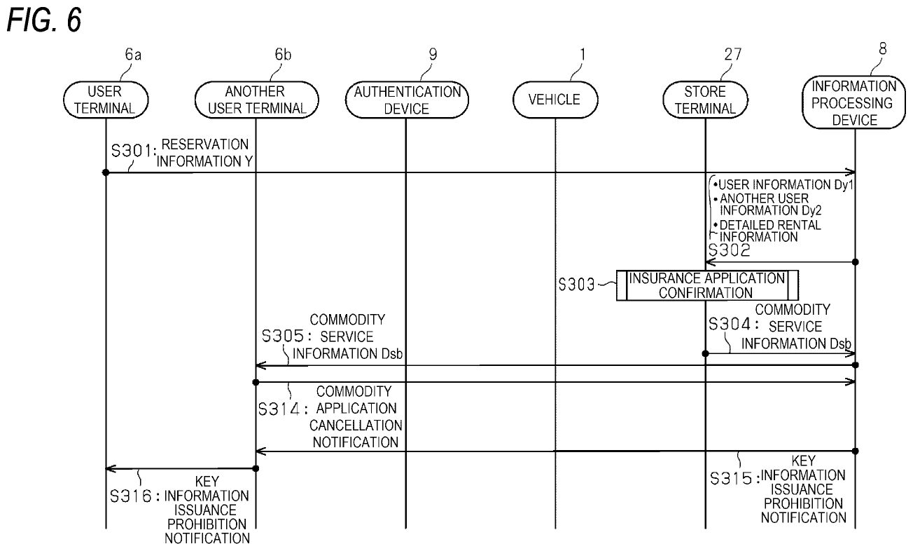

Next, operations and effects of the service provision system 25 according to the present embodiment will be described with reference to FIGS. 5 and 6.

As illustrated in FIG. 5, in step S301, the user terminal 6a transmits reservation information Y to the information processing device 8 via the network when a reservation operation for vehicle rental is performed on the user terminal 6a as “advance reservation”. The reservation information Y includes, for example, personal information (address, name, age, and the like) of the other user who is renting the vehicle, contact information (e-mail address or the like) of the other user terminal 6b, and detailed rental information of the vehicle 1 (reservation time, destination, presence or absence of high-speed road use, and the like). The reservation time is a time zone in which the vehicle 1 is rented to the other user.

In step S302, when the reservation information Y is received from the user terminal 6a, the information processing device 8 transmits, to the store terminal 27 through the network communication, information on a vehicle owner (user information Dy1), information on the other user who rents vehicle 1 (another user information Dy2), and detailed rental information of the vehicle 1. The user information Dy1 is personal information on the vehicle owner registered in the information processing device 8, that is, personal information related to a possessor of the user terminal 6a (address, name, age, account ID of the use of the authentication system 7, and the like). The other user information Dy2 is one type of personal information on the other user who rents the vehicle 1, and may be registered in advance in the database 30, for example, or may be acquired from the reservation information Y. The detailed rental information is a detailed content when the other user uses the vehicle 1, and preferably includes, for example, various types of information such as a reservation time, a destination, and presence or absence of high-speed road use.

In step S303, the notification unit 29 of the store terminal 27 confirms insurance applied to the other user who rents the vehicle 1 based on the user information Dy1, the other user information Dy2, and the detailed rental information acquired from the information processing device 8. In the present embodiment, the notification unit 29 confirms whether or not the other user has insurance by referring to the database 30 and confirming that the user has vehicle insurance.

In step S304, when the notification unit 29 confirms that the other user is not covered by the vehicle insurance of the user, for example, the notification unit 29 selects an insurance commodity suitable for the other user, and transmits information related to the insurance commodity (commodity service information Dsb) to the information processing device 8 through the network communication. The commodity service information Dsb is provided by, for example, selecting, for example, an optimum insurance commodity according to the conditions (reservation time, destination, presence or absence of high-speed road use) when the other user rents the vehicle 1 by checking the detailed rental information of the vehicle 1.

In step S305, when receiving the commodity service information Dsb from the store terminal 27, the information processing device 8 transmits the commodity service information Dsb to the other user terminal 6b via the network. When the other user terminal 6b receives the commodity service information Dsb, a screen related to the commodity provision and the purchase can be displayed on the other user terminal 6b. As a result, the other user can purchase the commodity through an operation on the other user terminal 6b.

In step S306, when the other user terminal 6b executes the operation of purchasing the provided commodity, a commodity application notification is transmitted to the information processing device 8 via the network. The commodity application may be, for example, a procedure for confirming whether only one commodity is provided and purchased, or a procedure for selecting one commodity from a plurality of provided commodities and purchasing the commodity.

In step S307, the information processing device 8 transmits the commodity application notification received from the other user terminal 6b to the store terminal 27 through the network communication.

In step S308, the notification unit 29 of the store terminal 27 executes a contract and application of the commodity (insurance commodity) selected by the other user based on the commodity application notification received from the information processing device 8. As a result, when the other user rents and uses the vehicle 1, the other user is also covered by the vehicle insurance.

In step S309, when receiving the commodity application notification from the other user terminal 6b, the second delivery unit 31 of the information processing device 8 generates the second key information Dk2 capable of operating the vehicle 1 with the other user terminal 6b, and transmits the second key information Dk2 to the other user terminal 6b via the network. In the present embodiment, the second delivery unit 31 generates the second key information Dk2 having a content different from that of the first key information Dk1 given to the user terminal 6a, and transmits the second key information Dk2 to the other user terminal 6b via the network.

The second key information Dk2 includes information obtained by encrypting a data group based on the content of the reservation information Y of the user. In the present embodiment, the second key information Dk2 includes, encryption information generated by using, for example, “reservation time”, “terminal ID (ID of the other user terminal 6b)”, “user authentication key” and the like as the original information and a cryptographic key of the authentication device 9 (for example, the unique key of the authentication device) provided on the vehicle 1 as an encryption key, and substituting these into an encryption expression (encryption algorithm). The second key information Dk2 is associated with the rented vehicle 1 and managed by the information processing device 8.

In a case where the vehicle insurance of the other user is also covered by the insurance of the user, the store terminal 27 transmits, to the information processing device 8 through network communication, for example, an insurance coverage notification indicating that the other user is covered in the insurance. The second delivery unit 31 of the information processing device 8 generates the second key information Dk2 and delivers the second key information Dk2 to the other user terminal 6b when receiving the insurance coverage notification from the store terminal 27. In this way, when the insurance of the other user is covered by the insurance of the user, the second key information Dk2 is registered in the other user terminal 6b without going through the procedure for the contract and application of the commodity.

In step S310, when the other user terminal 6b approaches the vehicle 1, the other user terminal 6b and the authentication device 9 establish short-range wireless communication (Bluetooth communication). As an example, when the other user terminal 6b receives an advertisement periodically transmitted from the authentication device 9, for example, device authentication (authentication of an ID, a password, and the like) is executed therebetween, and when the device authentication is established, the authentication device 9 and the other user terminal 6b are shifted to a state in which the short-range wireless communication is established.

In step S311, the other user terminal 6b and the authentication device 9 execute authentication of the second key information Dk2 registered in the other user terminal 6b in a state where the short-range wireless communication is established. Since the authentication of the second key information Dk2 is the same as that of step 104, the description thereof will be omitted. When the second key information Dk2 is correctly decrypted, a user authentication key and the like used for encryption at the time of short-range wireless communication with the authentication device 9 can be acquired.

In step S312, after the authentication of the second key information Dk2 is successful, when a door unlocking operation is executed by the other user terminal 6b, the other user terminal 6b transmits a door unlocking request to the authentication device 9 through the short-range wireless communication. A door locking operation includes, for example, an operation of touching a door locking button displayed on a screen of the other user terminal 6b.

In step S313, when receiving the door unlocking request from the other user terminal 6b, the authentication device 9 transmits the door unlocking signal to the system device 5 by UHF through the electronic key system 4. When receiving the door unlocking signal from the authentication device 9, the system device 5 unlocks the vehicle door by using the door unlocking signal as a trigger. As a result, the other user can open the vehicle door, get on the vehicle, start the engine, and drive the vehicle 1.

As illustrated in FIG. 6, when the other user cancels the purchase of the provided commodity, in step S314, the other user terminal 6b transmits a commodity application cancellation notification to the information processing device 8 via the network. Examples of a commodity application cancellation operation include an example of tapping a cancel button displayed on the screen of the terminal.

In step S315, when receiving the commodity application cancellation notification from the other user terminal 6b, the second delivery unit 31 of the information processing device 8 transmits, to the other user terminal 6b through the network communication, a key information issuance prohibition notification indicating that the second key information Dk2 cannot be issued. As a result, the fact that the key information Dk (the second key information Dk2) is not delivered to the other user terminal 6b is notified to the other user on the screen of the other user terminal 6b.

In step S316, when receiving the key information issuance prohibition information from the information processing device 8, the other user terminal 6b transmits the key information issuance prohibition information to the user terminal 6a via the network. As a result, the user terminal 6a is also notified the fact that the key information Dk (the second key information Dk2) is not delivered to the other user terminal 6b.

As described above, according to the present example, when the key information Dk (second key information Dk2) is delivered to the other user terminal 6b and the vehicle 1 is rented to the other user, the commodity (insurance commodity) related to the vehicle 1 is notified to the other user terminal 6b. In this way, when the vehicle 1 is to be rented to the other user, a guidance of the commodity provision related to the use of the vehicle 1 is performed. Therefore, when the vehicle 1 is rented to the other user, it is possible to prevent the occurrence of an undesirable use situation for the vehicle 1.

The service provision system 25 is provided with the second delivery unit 31, and when the other user purchases the commodity (insurance commodity) notified by the notification unit 29, the second delivery unit 31 delivers the key information Dk (the second key information Dk2) required for operating the vehicle 1 to the other user terminal 6b. Therefore, the purchase of the commodity provided by the notification unit 29 is set as a condition for key information delivery to the other user terminal 6b, so that it is possible to prevent forgetting to purchase the commodity when the vehicle 1 is operated by the other user terminal 6b.

The commodity or the service to be provided is a time-limited commodity with a set expiration date. Therefore, it is possible to simply and effectively cover the insurance only in a usage time period of the vehicle 1. When the use of the vehicle 1 is extended, the notification unit 29 updates the expiration date of the commodity in accordance with the extension. Therefore, when the use of the vehicle 1 is continued beyond the reservation time, the expiration date of the commodity is automatically updated, so that the time and effort required for the procedure of extending the expiration date of the commodity can be reduced.

The commodity is an insurance commodity of the vehicle 1. Therefore, when the vehicle 1 is rented to the other user, it is possible to easily guide the purchase of vehicle insurance. In addition, it is also possible to prevent forgetting to subscribe to the insurance.

An applicable time of the commodity provided by the notification unit 29 is set based on the reservation time of the vehicle 1. Therefore, it is possible to appropriately set an optimal commodity for the other user who rents the vehicle 1 by using the reservation time of the vehicle 1.

The present embodiment can be modified as follows. The present embodiment and the following modifications can be combined with each other as long as they are technically consistent with each other.

The commodity to be sold is not limited to the insurance (vehicle insurance), and may be, for example, a snow mountain item, a tire, a carrier, a mountain climbing item, a sea bathing item, a drive item, music, a movie, or the like.

The commodity provision is not limited to being executed via the information processing device 8, and may be directly output from the store terminal 27 to the other user terminal 6b, for example.

The commodity is not limited to being performed before the rental of the operation target 24 is permitted, and may be performed, for example, after renting the operation target 24.

The information processing device 8 and the store terminal 27 are not limited to being provided separately, and may be integrated.

The condition for the key information delivery to the other user terminal 6b is not limited to the purchase of the commodity, and the key information delivery may be permitted even if the product is not purchased.

The information processing device 8 may be a server.

The network communication is not limited to 4G, for example, and 5G or the like which is expected to be widespread in the future may be applied. The network communication includes, for example, communication via a relay device such as a wireless LAN.

In the second key information Dk2, the information different from the first key information Dk1 is not limited to information including restriction on the use of the vehicle 1, and may be information having at least a part different information from the first key information Dk1.

The key information Dk (first key information Dk1 and second key information Dk2) may be an encrypted data string.

Preferably, the second key information Dk2 given to the other user terminal 6b is automatically deleted when the reservation time has passed.

The use restriction set in the second key information Dk2 is not limited to a temporal restriction, and may be, for example, an engine start count restriction, a speed restriction, a traveling distance restriction, or the like of the vehicle 1.

The authentication device 9 is not limited to being connected to the electronic key system 4 by wireless communication, and may be connected by wired communication.

The authentication device 9 is not limited to being provided as a device independent of the electronic key system 4 (the system device 5), and may be provided as a device integrated with, for example, the system device 5 (a collation ECU that primarily manages authentication of the electronic key system 4).

The authentication device 9 may be a device capable of performing authentication by wireless communication with the mobile terminal 6 having a key function and capable of operating the vehicle 1 through the electronic key system 4 mounted in a vehicle.

The wireless communication (short-range wireless communication) between the mobile terminal 6 and the authentication device 9 is not limited to Bluetooth, and may be changed to another communication method.

Various frequencies may be used as the frequency of communication between the mobile terminal 6 and the authentication device 9.

The wireless authentication function (authentication system 7) may be a function in which the authentication device 9 provided on the vehicle 1 and the mobile terminal 6 authenticate (user authenticate) by wireless communication.

The electronic key system 4 is not limited to the smart collation system, and may be any system that performs authentication through wireless communication with the electronic key 2.

The electronic key system 4 may be configured to perform ID collation with the electronic key 2 through, for example, Bluetooth communication.

Various terminals other than the high-performance mobile phone may be applied to the mobile terminal 6. The user terminal 6a and the other user terminal 6b are not limited to the same terminal, and may have different forms, structures, and the like.

The notification unit 29 is not limited to being provided in the store terminal 27, and may be provided, for example, in another place such as the information processing device 8 or another server.

The other user who is notified of the commodity or the service is not limited to a person who has rented the vehicle 1, and may be anyone who can use the vehicle 1 on a mobile terminal 6 thereof.

The mobile terminal 6 to which the second key information Dk2 is delivered is not limited to the other user terminal 6b, and may be any mobile terminal 6 carried by a person who uses the vehicle 1.

The operation target 24 is not limited to the vehicle 1, and may be changed to another target such as a motorcycle or a bicycle.

Next, a technical idea that can be grasped from the embodiment and the modifications will be described.

In the service provision system, the commodity or the service may be a time-limited commodity with a set expiration date, and when the use of the operation target is extended, the notification unit may update the expiration date of the commodity or the service in accordance with the extension.

In the service provision system, the commodity or the service may be a vehicle insurance commodity.

As a part of the description of the present application, the contents of Japanese Patent Application No. 2018-245260 filed Dec. 27, 2018 is incorporated.

1. A service provision system in which an operation of an operation target is allowed when authentication is established via short-range wireless communication between an authentication device connected to the operation target and a mobile terminal having acquired key information required for the authentication, the service provision system comprising:
a first delivery unit configured to deliver first key information as the key information to a mobile terminal carried by a user of the operation target;
a second delivery unit configured to deliver second key information including information different from the first key information as the key information to a mobile terminal carried by another user different from the user; and
a notification unit configured to notify a mobile terminal carried by the other user of a commodity or a service suitable for use of the operation target through network communication.

2. The service provision system according to claim 1, wherein the second delivery unit delivers the second key information to a mobile terminal carried by the other user when the commodity or the service notified by the notification unit is purchased.

3. A service provision method in which an operation of an operation target is allowed when authentication is established via short-range wireless communication between an authentication device connected to the operation target and a mobile terminal having acquired key information required for the authentication, the service provision method comprising:
a step of delivering first key information as the key information to a mobile terminal carried by a user of the operation target;
a step of delivering second key information including information different from the first key information as the key information to a mobile terminal carried by another user different from the user; and
a step of notifying a mobile terminal carried by the other user of a commodity or a service related to use of the operation target by a notification unit through network communication.
